(19) United States
(12) Patent Application Publication
(10) Pub. No.: US 2007/0103342 A1
(43) Pub. Date: May 10, 2007

(54) Dynamic Modification And Communication Of Routes For Transportation Vehicles

(76) Inventor: Dan P. Milleville, Ayer, MA (US)

Correspondence Address: NIELSON LAW OFFICE, 1212 HANCOCK STREET, SUITE 120, QUINCY, MA, 02169, US

(21) Appl. No.: 11/309,171

(22) Filed: Jul. 5, 2006

Related U.S. Application Data
(60) Provisional application No. 60/696,652, filed on Jul. 6, 2005.
(60) Provisional application No. 60/709,757, filed on Aug. 22, 2005.

(51) Int. Cl. G08G 1/123

(52) U.S. Cl. 340/988

(57) ABSTRACT

Methods and an automated digital applications are disclosed that can assist in the operation, scheduling and vehicle maintenance of transportation companies, and especially those involved in the transportation of special needs persons having routine schedules, e.g., between home and school, subject to dynamic changes. The methods provide for exception request handling via receiving exception requests for scheduled and non-scheduled route changes whereby multiple dispatchers can effectively and efficiently modify routes in multi-vehicle operations, alter other dispatchers of the change(s) and communicate new route information to operators of the vehicles. Further, routine and non-routine, as well as vehicle maintenance and cost analysis, are provided by the methods.

### CROSS REFERENCE TO RELATED APPLICATIONS

This application claims priority from U.S. Provisional Application No. 60/696,652 filed Jul. 6, 2005, and U.S. Provisional Application No. 60/709,757 filed Aug. 22, 2005, both of which are incorporated herein by reference.

### BACKGROUND OF THE INVENTION

Scheduling, dispatching and tracking transportation and/or delivery vehicles, such as passenger vehicles, have been accomplished in a number of ways, many of which have proven to be useful for generalized transportation/delivery requirements. For example, a bus transportation company might have numerous scheduled routes and one or more buses scheduled to travel along each route in a loop, that is, continuously traveling around some path. Potential passengers, generally unscheduled ones, can wait at pre-selected locations for the next bus to come along. As a bus approaches, should the driver observe passengers waiting, he or she stops the bus allowing the passengers to enter and ride along the route. Conversely if there are no passengers waiting the bus does not stop. Similarly, passengers on the bus can signal an operator to stop at the next stop to let the passenger exit the bus. But generally, the bus stops only at pre-selected points, and the bus travels along a common, often published, route.

In contrast to that scenario, there are somewhat specialized transportation services that require complex scheduling, dispatching and tracking. Such can be the case for transportation companies providing passage for special needs school students. For example, a transportation company devise scheduled pickup locations, e.g., a persons address, wherein a single (or just a few) passengers are specifically schedule for pickup. Those passengers may have a single destination, or just a few destinations, e.g., a school or other facility, and each passenger must arrive at his or her destination by a determined time, e.g., the start of the school day. Complexity is added, however, via exception requests wherein one or more passengers may notify the company that a pickup that day is not required. Exception request handling has been, to date, difficult given the size of many transportation companies, last-minute receipt of such requests, licensing requirements of both vehicles and operators, vehicle maintenance requirements, and other criteria and circumstances.

Indeed, the above noted problems are amplified when a transportation company can have tens, hundreds or even thousands of vehicles of various types, e.g., buses, vans and wheelchair carriers. Such a company may have multiple dispatchers each tracking numerous vehicles. When an exception is received, it must first be tracked to a vehicle, yet many times, the specific vehicle cannot be determined due to misspellings of passenger names, errors in recording the exception information, and failure to inform the correct dispatcher(s). Exceptions can either be lost causing a vehicle to travel to a location having no passengers, or multiple dispatchers mistakenly each dispatch a vehicle to a given stop causing multiple vehicles to travel to pickup up the same passenger. Further, because vehicles have a maximum number of passengers that it can carry, dispatchers must know how many passengers are already being transported, or need to be transported, and whether that vehicle would exceed its capacity by picking up a further passenger.

Licensing restrictions can also be a problem since regardless of the vehicle some operators might be licensed to transport only a given number of passengers at any one time. Thus, even though a given vehicle can carry another passenger, the driver of that vehicle may not have proper licensing to carry that number of passengers.

Thus, there is a need to increase dispatcher efficiency and help ensure that vehicle maintenance requirements are satisfied. There is a need to reduce costs relating to exception handling for transportation companies. There is a need to satisfy those and other objectives.

### SUMMARY

Those and other objectives are satisfied by the invention which provides in one aspect, methods for dispatching vehicles and dynamically modifying routes according to asynchronously received exception requests and communicating those requests to one or more dispatchers in a timely manner. Routes for one or more transportation vehicles, e.g., busses, passenger vans and the like, are determined. Each route has at least one first location wherein one or more passengers are gathered, and at least one second location wherein one or more of the passengers are discharged. One or more vehicles are assigned to each route, each vehicle having an associated one or more operators. Exception requests can be received by a dispatcher or other person, or electronically or otherwise, requesting that one or more locations and or passengers be added, omitted or otherwise modified. In response, a dispatcher determines the affected route and vehicle(s) and modifies the route according to the request. The operator(s) are notified. Advantageously, other dispatchers are notified of the modification thereby preventing situations where the first location is still scheduled or multiple vehicles are scheduled to arrive at the same location to gather the same passenger.

In a related aspect, vehicle usage characteristics, e.g., mileage, maintenance and/or operating costs, are calculated or otherwise determined and tracked. Scheduled and non-scheduled maintenance requirements can be forwarded to an appropriate dispatcher, generally in the form of an exception request, who can then account for any period where the vehicle(s) is/are not available due to the scheduled maintenance. Accordingly, the dispatcher can move passengers between vehicles, assign alternate routes and/or operators, and inform or advise passengers of delays or other changes.

According to another aspect to the invention, methods such as the ones described above can be embodied in an automated computer system and/or network, for example, and provide methods for dispatching transportation vehicles, especially in the area of transportation of special needs students between their homes and/or residences and schools and/or facilities. In one embodiment, an application has a database that is populated with route, dispatcher, schedule, operator, vehicle, passengers and/or maintenance information, among other data. Exception requests can be received and associated with equipment and personnel, e.g., responsible dispatcher, vehicle(s) and operator(s), each are identifiable via one or more automated searches. The information can be transmitted to one or more dispatchers associated with or who have authority to modify routes, schedules, first and second locations, and other criteria as required. Thus, an effective and efficient solution can be implemented that encompasses the requested exceptions.

### BRIEF DESCRIPTION OF THE DRAWINGS

Additional benefits and advantages of the present invention will become apparent to those skilled in the art to which this invention relates from the subsequent description of preferred embodiments and the appended claims, taken in conjunction with the accompanying drawings, in which:

FIG. 1 illustrates one embodiment of methods according to the invention for providing a transportation company to dispatch vehicles according to an initial schedule and dynamically modify the schedule in response to receiving exception requests;

FIG. 2 illustrates one example of simplified transportation routes for gathering special needs students and shows identifiers that can be stored in a database;

FIG. 3 shows an embodiment of an main display screen of an application providing a dispatcher or other user of the application an interface to a database;

FIG. 4 shows the main screen of FIG. 3 having passengers for a route displayed.

FIG. 5 shows a display screen according to the invention having passengers displayed that can be selected to provide additional information and/or editing of a selected passenger's information;

FIG. 6 shows an embodiment of a notification box according to the invention;

FIG. 7 shows an embodiment of a selected passenger's route schedule; and

FIG. 9 shows an embodiment of a vehicle maintenance display.

### DETAILED DESCRIPTION OF ILLUSTRATED EMBODIMENTS

The invention provides methods and digital applications embodying those methods for increasing transportation dispatching efficiency, ensuring notification of timely vehicle maintenance, and ensuring compliance with operator and/or vehicle regulations and licensing. The methods can be directed to dispatching one or more transportation vehicles along one or more routes. Each route has one or more first locations wherein one or a few cargo items such as passengers and specifically such as special needs students are scheduled for pickup, and has one or more scheduled second locations where many of the cargo items are discharged. The methods provide effective and efficient processing of dynamically received exception requests to the route and/or schedule, such as temporarily deleting and/or adding first and/or second location(s) through advising a dispatcher that a specified cargo item will or will not be available for pickup or drop off. Through communicating the exception request to an appropriate dispatcher, the route and affected vehicles can be identified and re-scheduled as appropriate. Further, notification of the action is communicated to other dispatchers advise them that the proper action has been taken, and thus, that no further action should be taken. Advantageously, the methods aid transportation companies having tens, hundreds or even thousands of vehicles of various types (e.g., busses, vans, large capacity and/or small capacity), and having multiple dispatchers each responsible for dispatching and tracking a plurality of vehicles, and/or having tens, hundreds or thousands of cargo items, some of which can have special requirements, e.g., medical conditions requiring attention.

It will be appreciated by those skilled in the art that the methods herein can provide efficient dispatching and vehicle maintenance records for transportation needs involving transporting special needs students, although the methods are suitable for other applications as well. Indeed, because of a wide variety of transportation companies, the embodiments illustrated herein include a simplified example of a school busing company responsible for transporting special needs students to one school. Nonetheless, methods taught herein are useful in other fields of transportation, such as transporting laboratory samples from multiple doctors' offices to one or more laboratories each work day, for example. Those are, of course, merely two non-limiting examples and others will be apparent to those skilled in the relevant art.

A special needs transportation company is, in general, responsible for picking up special needs students, generally at his or her house, using a suitable type of transport depending on the special needs, e.g., a bus, van, wheel-chair car or otherwise. The transport vehicle should arrive at a student's house, herein referred to as a first location, at or before a determined or selected arrival time. The vehicle may travel to a plurality of first locations, each having one or just a few students, and must arrive at each first location at or before the arrival time. Then, or intermixed in-between first locations, the vehicle travels to one or more second locations, such as a school or facility, to drop off all or a portion of the students and generally more than one student. The vehicle must arrive at that (or those) second location(s) at or before a further scheduled time(s). When the methods are directed toward such applications as special needs students, the same or similar routes are scheduled for each school day. Even so, occasionally, one or more students may not be traveling to school, thus, as used herein, an exception request refers to a request communicated to the transportation company, e.g., a dispatcher or other designated person, requesting that a pickup for one or more days be canceled or added. For example, a student may be ill or otherwise not attending school that day. In such event, a parent may telephone the transportation company to cancel pickup for the day, week or other period. Further, a student who is not regularly scheduled for pickup could request a pickup for a given day, or might select an alternative second location for a day, week or other period. In response, the company would re-route identified appropriate vehicles and/or adjust schedules, often after the identified vehicle(s) are already in route.

The complexity of dispatching transportation vehicles and maintaining vehicle maintenance records becomes more apparent when viewed in terms of transportation companies having hundreds or thousands of vehicles, and multiple dispatchers each responsible for dispatching multiple vehicles along multiple routes. One consideration, for example, relates to vehicles having certain restrictions, e.g., a maximum number of passengers that must be tracked when a new first location is added. Operators of vehicles may also have licensing restrictions that limit the number of passengers that may be present in a vehicle, even though the vehicle may physically allow additional students to be transported. Even further, some students may require operators that have special training in aiding those with certain special needs (e.g., certain behavioral and/or medical problems). Those, and other criteria, are preferably considered by dispatchers when exceptions are received.

Further still, vehicle maintenance records are generally maintained for student transport vehicles under regulations, guidelines and/or statutes, on federal, state and/or local levels. Thus, because exception handling will result in differing travel patterns than those originally planed for, vehicle maintenance may be required earlier or later than originally planned. Advantageously, the methods herein provide an effective and efficient manner of ensuring that vehicles are properly maintained via generating exception requesting that one or more vehicles be removed from being utilized for maintenance. Those exception requests are handled in much the same manner as the ones described above.

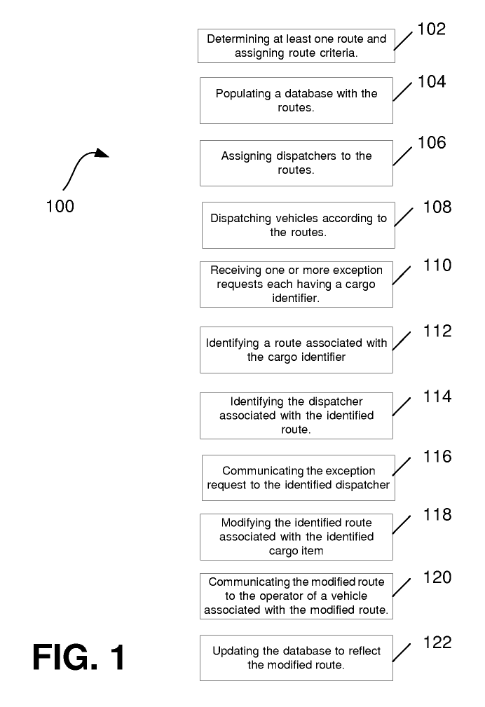

FIG. 1 illustrates methods 100 for increasing efficiency of dispatching and maintenance of vehicles according to one embodiment of the invention. Step 102 involves determining at least one initial route, although advantageously, tens, hundreds or even thousands of routes can be determined. Step 104 includes populating a database, preferably by using the determined routes. For example, routes determined in Step 102 can be imported into a database that can provide access to the data, e.g., the routes for displaying, editing, modifying adding, deleting and other functions, and has the ability to store associated data regarding those routes. Step 106 involves assigning and/or associating one or more dispatchers to the one or more routes. Step 108 involves dispatching one or more vehicles along the one or more routes. Before, during and/or after vehicles are dispatched, Step 110 provides for receiving exception requests relating to one or more cargo items, e.g., special needs students. A central location, for example, can be assigned responsibility for receiving exception requests and Step 112 involves identifying one or more affected routes, and thereafter, step 114 involves identifying one or more dispatchers associated with those one or more affected routes and identifying one or more vehicles along that route. Step 116 provides for communicating the request or a portion of that request (e.g., an affected route) to one or more dispatchers responsible for one or more vehicles of the affected route. For example, a single exception request may affect two routes, each route having a dispatcher. Step 112 provides for identifying those routes, Step 114 involves identifying the dispatcher associated for each of those routes, and Step 116 provides for communicating to each of the dispatchers sufficient information to modify the route that he or she is responsible for. Step 118 involves modifying the route(s) which can include adding/deleting locations, assigning different vehicles, and/or swapping cargo items into a different vehicle. Step 120 involves communicating the change(s) to the operator(s) of affected vehicles along the route(s). Step 122 provides for modifying the database to reflect the changed routes, and thus, modifying maintenance records of the vehicles, as well as blocking or otherwise notifying dispatchers that the changes have been made to prevent duplicate changes and/or prevent no change from taking place.

It will be appreciated by those skilled in the art that the methods illustrated in FIG. 1 are but one embodiment of methods of the invention, and that there are other embodiments wherein the steps of the methods can be combined or separated in differing ways, and indeed, some steps may be performed in various sequences not illustrated.

Step 102, as noted above, involves determining at least one route having a first location and second location (or a plurality of either or both), which in turn, is based on identified cargo items to be transported from the first location(s) to the second location(s). Each location, whether a first or second location, has an associated time parameter, e.g., an arrival time, giving an indication of arrival at an associated location, at least one cargo identifier, and other attributes, definitions and/or identifiers as appropriate for a given transportation application. Determination of one or more routes preferably takes into consideration the number and types of vehicles available, e.g., buses, vans, wheel-chair cars and the like. For example, a bus can, in general, transport more passengers that a van, and therefore, it can be associated with a route having more first locations that a route having an associated van. Yet, operational costs of a bus are typically higher than that of a van; thus the smaller vehicle can be associated with a smaller route. Of course, a single route may have multiple vehicles and those vehicles may be of various types, e.g., a bus and a wheel-chair van capable of transporting a student requiring such assistance. Further, second locations may be intermixed with first locations, and thus, as passengers exit at a second location, additional ones may be gathered there or at further first locations.

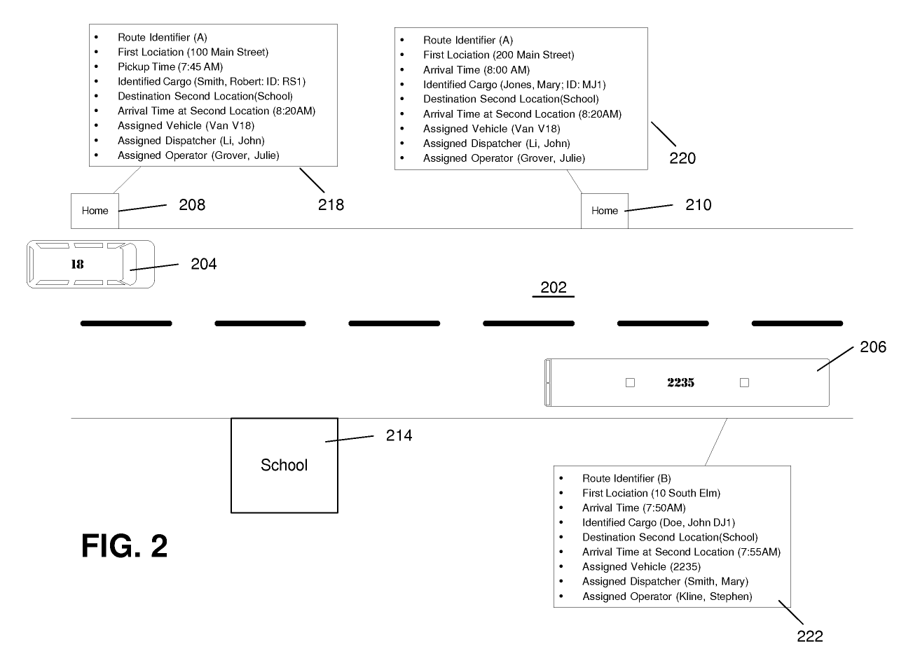

FIG. 2 illustrates a non-limiting example of two routes such as the ones described above, albeit in simplified form to facilitate understanding. Illustrated is a road 202 or other path along which transportation vehicles 204 206 can travel. Vehicle 204 is a van capable of transporting six students, for example, and vehicle 206 is a bus capable of transporting 34 students, for example. Along the road are locations 208, 210, 214, some of which are first locations 208, 210 and another is a second locations 214. In practice, there are numerous first and second locations, and indeed, some second locations along a route can be first locations along a further route where a student is transferred to another vehicle to continue his or her journey to a final second location (e.g., a school).

Continuing with the example, first location 208 can be a special needs student's home where that student is gathered or picked-up each school day at 7:45 AM (see Box 218) and transported to a second location 214, here denoted as a school. A further first location 210 can be a second student's home who also requires transportation each school day to the school. Of note in this example, the two students, identified here as “Robert Smith” Box 218 and “Mary Jones” Box 220, live in close proximity and hence, a single route can include gathering both via first locations 208 210, although in practice many considerations comprise a decision of assigning locations to routes and some of those are discussed below.

Referring to Box 218, that single route is identified as Route A although a route identifier can be virtually any unique identifier comprising any number of symbols, letters, numbers or otherwise.

Because the locations 208 210 are illustrated as those where a student is gathered, they are referred to as first locations, and each is given a unique identifier: location 208 is identified as “100 Main Street” (Box 218), and location 210 is identified as “200 Main Street” (Box 220). As illustrated, the destination of each student is the same, to wit, “School”, and each has an arrival time of 8:20AM making it possible that the two students may be assigned to a single route, see step 102. Advantageously, methods described herein are useful for transportation needs where one or a few cargo items are gathered at each first location, and many or all of the cargo items are discharged at a second location, although there are exceptions and modifications that will be appreciated by those skilled in the art. Of note, however, in reference to first and second locations, is that a first location for one cargo item can also be a second location for a second cargo item. And a single location can be a transfer point wherein a student is dropped off to wait for a second transportation vehicle, and hence, that location can be a second location for that cargo item along a first route, and a first location for that cargo item along a second route. Other combinations will be appreciated by those skilled in the art. As described above in reference to route identifiers, a location identifier can also be virtually any unique identifier comprising any number of symbols, letters, numbers or otherwise.

Because Route A has only two cargo items along its path (in the simplified example illustrated), here identified as students RS1 (Box 218) and MJ1 (Box 220), a vehicle 204 of a type that can transport at least two students simultaneously has been selected, and that selection is based on efficiency of transporting a number of students, any special needs of the students, e.g., wheel-chairs, special support requirements and behavioral challenges, number of other passengers already or yet to be gathered, and/or operator licensing restrictions, and other criteria. Transport vehicle 204 has been identified as V18, although virtually any identification can be used.

Similar to Route A, a second route designated as Route B is determined, see Box 222. Therein, as described above, is a first location and an arrival time at that first location, a cargo identifier (“Doe, John DJ1”), a second location “School” with an arrival time of 7:55. The Bus 206 identified as “2235” has been selected for Route B, and that can be based on criteria such as those described above and other criteria as appropriate. Further, Route B has an assigned dispatcher (identified as “68”) and operator (identified as 2217). Thus, it will be appreciated by those skilled in the art that routes are determined based on a wide variety of criteria, and indeed, multiple routes can be determine.

With that understanding, returning to FIG. 1, subsequent to determining at least one route as described in step 102 above, populating a database with those routes, step 104 can be accomplished. The database can be of virtually any design, as many are known in the art, but preferably, it can link or otherwise store and access data related to the dispatching of transportation vehicles along a route and can accept and maintain changes to the routes. For example, the database may be of electronic type, such as one or more commercially available databases, or a custom designed database. In any case, populating the database with the routes, step 104, involves transferring criteria such as that described above in conjunctions with FIG. 2, for use by at least dispatchers. Preferably, the database can access route and schedule information, and can be used to ascertain at least a route using a cargo identifier as a key. In one embodiment, a database can be electronically populated via transferring data through a network or other digital mean, although in another embodiment a database is populated as routes are developed using a digital software package encompassing both determining the routes and populating a database, for example, as will be illustrated below.

Once the routes are developed and the database populated, assigning dispatchers to the routes, step 106, is accomplished based on staffing requirements, the size and number of routes, and the qualifications of the dispatchers, e.g., whether specialized knowledge of the routes and/or cargo is required. For example, after a staffing plan has been developed, assigning dispatchers can be accomplished.

Dispatching vehicles according to the routes, step 108, can be accomplished by dispatchers or other personnel and as noted above, consideration should be given to criteria similar to those already noted. In one case, operators can radio or otherwise contact a dispatcher assigned to the route, for example, whereby the dispatcher can provide direction to begin the route.

Receiving exception requests, step 110, can be accomplished in a variety of ways, but preferably, an exception request contains at least one cargo item identifier that can be used as a key to determine a route or routes associated with that cargo item, and consequently, a dispatcher assigned to that route. In the example illustrated in FIG. 2, a cargo item identifier can be a student's name, however, the name can be derived from a first location identifier (e.g., the student's address for pickup), or the student's ID, e.g., RS1 (Box 218). For example, a student may be ill and not attending school for the day, thus, the transportation company may receive a phone call informing the company that a pickup is not required for Mary Jones (ID: MJ1) that day or that week. A student who generally does not require a pickup may call requesting a pickup for that day, and an appropriate route can be gleaned from the database referencing a possible route for that pickup. These are but a few examples, and many others are envisioned, as long as an exception request contains a cargo item identifier or other means of identifying a route associated with the exception request, and requests that an exception (e.g., addition, subtraction or other modification) be made to a regularly scheduled route. In any event, receiving exception requests can be accomplished via telephone, radio, electronically, e-mails or other communication means. In one embodiment where vehicle maintenance is also stored in the database, maintenance requests can be issued via exception requests as well, and that is described below.

Advantageously, a search key can be used for the step of identifying a route, step 112, and the key can be a cargo item identifier. Identification can be accomplished in a wide variety of ways such as look-up tables or other tables, or it can be accomplished via electronic means where the methods are incorporated into electronic and/or digital systems utilizing databases. Further, search methods can be utilized such as so-called soundex™ methods, providing error correction when a certain cargo identifier is not found in the database. Of course, a database can be searched using a variety of keys to determine a variety of information, for example, a vehicle identifier can be used to determine possible routes and for each, possible cargo items disposed therein, and other examples will be appreciated by those skilled in the art.

Step 114, Identifying a dispatcher, can be accomplished using the database, and may produce one or more dispatchers responsible for a given route. In the case of multiple dispatchers, the methods herein encompass selecting one of those dispatchers identified based on rules and/or procedures according to the transportation company, for example.

Step 116, communicating the exception request to the identified dispatcher, can be accomplished in a variety of ways from hand-delivering the request to a dispatcher to electronically sending the request to the dispatcher, and many other ways as will be appreciated. Multiple dispatchers may be notified of the exception request, yet the methods provide that only one can modify the associated route and the others will be blocked or notified that that a further change should not be made.

Step 118, modifying the identified route, is generally performed by the receiving dispatcher, however, the route may be modified using automated means. In any event, the route can be modified to exclude or include additional first and/or second locations, pickup and/or drop-off cargo items, or other modifications. As noted in connection to step 102, modifications preferably account for a type of vehicle, operator licensing constraints, utilization of the vehicle, maintenance aspects, and other considerations as both noted above, and as will be appreciated by those skilled in the art. In some cases, modifying a route may involve modification one or more other routes. For example, a dispatcher may determine that the vehicle assigned to a route has already passed a requested pickup, but a different vehicle on a different route is in the area. Alternatively, a selected vehicle may already be full; hence a further vehicle on a further route may be selected and its route will be modified to include the location. Those and other cases are envisioned and encompassed by the methods of the invention.

Step 120, communicating the modified route to an operator of the vehicle, is performed after the route is identified and modified. The communication can take place in any number of ways such as mobile phones, electronic transceivers, and/or alpha/numeric displays. In one embodiment, an operator has the means for acknowledging the communication providing feedback to the dispatcher that the modification can be accomplished or otherwise. For example, an operator may be unable to accomplish the modified schedule for a variety of reasons including licensing restrictions, special considerations for the cargo items, and others, and that can serve as a cross-check of the applicability of the modified route.

Step 122, updating the database, can be performed by the dispatcher or by other personnel, or even electronically. Further, step 122 can be performed before, after or together with step 118, depending on considerations of the implementation of the methods presented herein.

Those skilled in the art will appreciate that the methods illustrated in FIG. 1 are but one embodiment of the invention and that modifications will be envisioned by those skilled in the art. For example, in one embodiment, vehicle maintenance parameters are also maintained in the database, and can be considered while determining routes. Generally, certain vehicles preferably have periodic inspections based on mileage and/or time period, such as yearly inspections, routine maintenance after a certain number of miles or hours of operation, and the like. Further, certain vehicles scheduled for routes may be out of service for a variety of reasons. Thus, determining schedules can also account for necessary maintenance and/or out-of-service vehicles. Alternatively or in conjunction with, maintenance and/or out-of-service conditions can be handled via exception requests, wherein such a request can be communicated via automated notification to a dispatcher or other receiving personnel, or it can be communicated via electronic, telephonic, e-mail or can be generated via other electronic means to the appropriate personnel and/or dispatcher.

In practice, the methods described above can be embodied in an application such as a digital computer processor program and executed on one or more digital processors, e.g., PCs, networks, server systems and the like. One example of a program embodying methods such as the ones described above is now described, although it should be understood that it is a non-limiting example. Those skilled in the art will appreciate that described herein is an operational guide as well as a description of the application, and that the methods described above are implemented in the application. Of course, it will also be appreciated that the methods can be otherwise embedded within a wide variety of automated systems, e.g., within software, firmware, hardware, or via remote download/upload systems. And further, graphical user interfaces such as those illustrated below can be and will be modified within the scope of this invention and are envisioned.

A database can be populated or loaded with information relating to the transportation company, vehicles, passengers, schedules and drivers, among other data, and as a workday starts, dispatchers can execute the application on their PC or other suitable equipment.

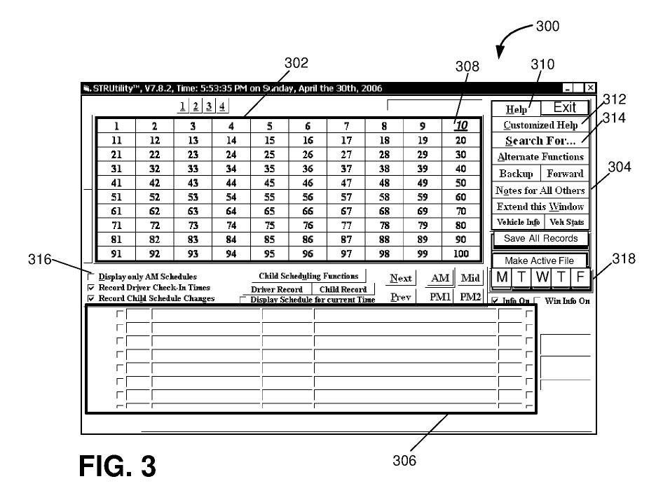

Illustrated in FIG. 3, is a main screen 300 generated by the application. As a prerequisite to displaying the main screen 300, a user can be requested to provide a username and password (not shown). User names and passwords can be managed via administrators, management, information technology specialists or other personnel having authority to manage user accounts. Therefore, there can be various classes of users, as will be appreciated by those skilled in the art, each class having differing authority to access certain functions, e.g., add/modify users (e.g., dispatchers), assign passwords, and the like. Preferably, the application can store certain personal information relating to one or more cargos item such as medical information relating to passengers alerting certain dispatchers and/or operators to be aware that certain emergency or other events may occur, e.g., diabetes, behavioral problems and the like. Thus, special care should be taken to prevent unauthorized access and/or dissemination that that and other protected or personal information and that can be handled through user access, passwords and user classes.

Main screen 300 provides access to a wide variety of functions and features of the application, and has a selection window 302, a command window 304, a data window 306 and other display and/or input areas or check-box features providing a user (e.g., dispatcher) to narrow or broaden displayed information, provide input, and make other selections. Selection window 302 can be used to select a route, for example, and illustrated is a highlighted route identifier button 308 indicating that “Route 10” has been selected. Additionally, selection window 302 can be used to receive notification messages from an administrator, other dispatchers or automated messages generated by the application. Selections can be made via a pointing device such as a mouse, although other methods are known in the art and many can be utilized herein, e.g., “alt” or “cntl” key sequences. Of course, the application can produce a wide variety of highlights including colorized ones on color-capable terminals. Advantageously, that can provide a color system for notifications, e.g., a route number can change color (e.g., red, yellow, green) indicating that dispatcher action is requested and/or required or is an informational notification or an urgent notification that requires immediate attention.

Command window 304 provides access to one or more commands. For example, a help button 310 can be selected providing generalized assistance as opposed to a Customized Help button 312 that can provide user-specified context sensitive assistance.

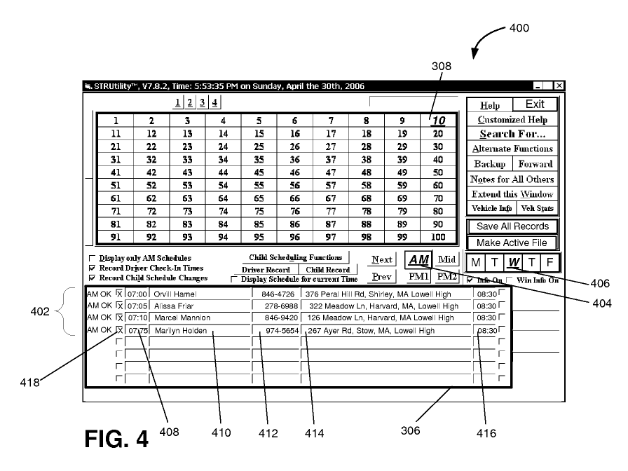

Data window 306 can be used to display and or edit information obtained via search, e.g., via selection of a Search For button 314, and one example is illustrated in FIG. 4 having a populated data window. It will be appreciated by those skilled in the art that subsequent or prior to selection of the Search For button 314, search parameters can be entered by a user, and those parameters can be augmented via selections made elsewhere, e.g., the selection window 302, click boxes such as click box 316, and selection of certain days of the week 318.

FIG. 4 illustrates the populated data window 306 as noted above. Passengers 402 are displayed in the data window 306, and further, those passengers are scheduled to be gathered along Route 10 as indicated by highlighted button 308. Further, the passengers are scheduled for morning transportation as indicated by highlighted button 404 on Wednesday as indicated by highlighted button 406. Passenger information includes a pickup time 408, name, 410, contact number 412, a first and a second location 414, and a drop-off time 416. Further, the data window indicates that the passengers 402 are all currently scheduled for pickup as indicated by an “OK” check box 418. A dispatcher or other user can de-select a passenger for pickup by removing the “OK” indication via clicking on it or otherwise toggling the check box. That change can cause the identifying button for that vehicle to change to an identifying color, e.g., yellow, and that button's new color, or another identifying color, can propagate through the database thus notifying any or all of the other dispatchers that Route 10 has been altered and may permit further changes, e.g., that the assigned vehicle will have an unoccupied position that may be available for another passenger should the need arise.

Through propagating a status of the identifying buttons, dispatchers are alerted of changes providing means for timely communication of those changes to vehicle operators. Advantageously, even if another dispatcher is observing schedules for vehicles on various other routes, he or she can be alerted that an exception request has been registered due to the color change of the vehicle(s) associated button, and if appropriate, can take action to notify the operator. Of course, the opposite is also true in that once the position is assigned, the other dispatchers will accordingly be notified that the seat is occupied preventing double-assignments of positions, and that is advantageous where many dispatchers are controlling many vehicles along many routes.

Another feature of an application such as the one described herein provides means for responding to a radio check and subsequent dispatching of vehicles. For example, a dispatcher can respond to a vehicle operator's radio check or call-in indicating that the vehicle is ready to begin travel along one or more routes. The operator can call in for a radio check in the morning, and in response a dispatcher presses a button with that Vehicle's ID on it, e.g., ‘10’, illustrated in FIG. 4, a main screen 402. The application can then display a passenger list such as the one described above in FIG. 4, alerting the dispatcher to any changes that have occurred. Such changes might have occurred because of an exception request or other request, or a maintenance event such as scheduled or non-scheduled maintenance. But in any event, the change can be indicated in the passenger list by utilizing highlighting as described above or other indication. If there are no changes, or any change has been communicated to the operator, the dispatcher can again select, e.g., double-click, that vehicle's button causing it to change color, e.g., white, to indicate that the vehicle is in service. As noted above, that change in color preferably propagates through the database and is displayed on the other terminals. Later when the morning route is complete, the driver can again radio the dispatcher of that status, and the button can be again selected, and will thus appear in a color, e.g., blue, other dispatchers' terminals. The same procedure can be carried out for other routes, e.g., an afternoon or evening route for such events as check-in, exception modifications, and completion.

As noted above, an exception request can be received by a dispatcher, office attendant, or other personnel as assigned by the transportation company, as well as via electronic means such as e-mail. For example, a parent of a passenger may telephone the transportation company to inform it that his or her child will not require transportation services on a certain date. It is likely given the number of students being transported each day, week or month that a dispatcher will not be aware of which vehicle and/or operator is scheduled to pickup that passenger. Advantageously, the application provides a search feature via the Search For button 314 (FIG. 3). The dispatcher can enter a first and/or last name with any spelling approximated as the application can utilize fuzzy or soundex methods for searching, and those can produce results within a band of accuracy, e.g., within 70% correct based on a criteria. The searched for child's information can be displayed in any of a wide variety of formats, but in any event, one or more schedules for that child are displayed. Exception information, e.g., route modifications, can be entered for the appropriate days, weeks, or months and stored in the database. Changes are communicated in the appropriate manner, e.g., daily route information, with proper notification to dispatchers and operators.

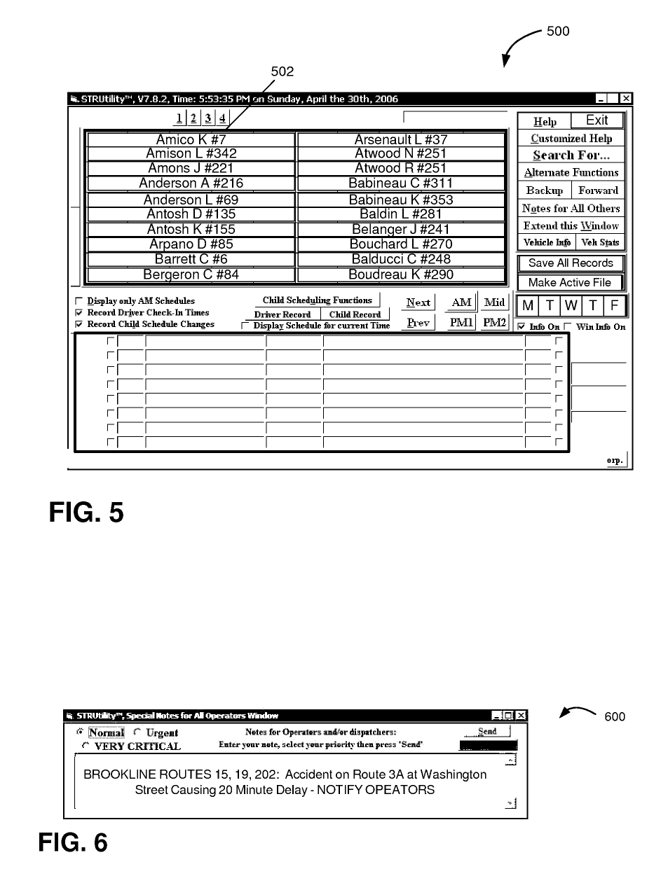

FIG. 5 shows a main screen 500 having a selection window 502 populated with passenger names rather than route identifiers. Preferably, a dispatcher or other user can select what type of information is displayed in the selections, thus allowing the data to be switched or selected between various types, e.g., routes, passengers and vehicles, and FIG. 5 shows a section window after the operator selected to display passengers. As described in connection with main screen 302 above, passenger data can be selected using the button features of selection widow 502, thereby presenting detailed information related to the selected passenger. That information can include contact numbers, any medical or special considerations, address, destinations, route assignments, special needs and the like.

As with routes and passengers, dispatchers can identify and/or find vehicles either by identifiers, associated operators, characteristics (e.g., wheel-chair vans), or other criteria. Further, operator personnel can be displayed using the same or similar means. In any case, the resulting information can be displayed via a selection window such as the ones described above.

An application such as the one described here can also provide a current status or condition of the one or more routes, and that is advantageous for providing to dispatchers sufficient information to modify routes, vehicles, schedules and/or passengers, for example, prior and subsequent to receiving exception requests. Routes can be denoted as started, finished or delayed, for example. Route information is then stored in the database providing current data to all dispatchers and users of the application. The application can highlight route information status via a main screen by using a color code, e.g., green for current vehicle information displayed, various shads of gray for different modes of an inactive status (such as populated, spare or out-of-service), red for in maintenance, yellow for an exception that remains to be communicated to an operator, blue indicating that the vehicle is available as an extra transport, or white indicating a vehicle is in service. Those skilled in the art will understand that those are only examples and other colors, status types, alerts (e.g., flashing and audio) can be used.

Thus, when a route has been completed by any particular vehicle operator, that operator can notify his or her dispatcher who can again select via clicking or double-clicking with a pointing device, that vehicle's identifier button, causing it to turn blue (or to otherwise change visually or audibly) to so indicate and notify the other dispatchers via a respective main screen. At the end of a day, an operator can notify a dispatcher that all runs have been completed, and the dispatcher can again cause the color or other display characteristics of the selected button back to its original color, e.g., gray as described above. Thus, dispatchers and maintenance personnel can quickly ascertain the current status of any vehicle.

FIG. 6 shows a notification 602 that can be entered by a dispatcher or other personnel and sent to one or more other dispatchers according to selected criteria, e.g., by association with one or more routes, passengers and vehicles. Notifications can provide specific information by association with one or more routes, passengers and/or vehicles, or any of a wide variety of other information appropriate for transportation tasks. Notes can be a free-form style or a formatted style, and entered and sent to one or more dispatchers or users using pop-up style notification. Notifications can be assigned importance or priority. Thus, emergency notifications can be displayed at one, several or all user terminals according to a selected priority, e.g., urgent notifications can be sent to all terminals while a route priority notification can be sent only to one or more dispatchers associated with information contained in the notifications. Further, priorities can be assigned via a color code or differing pop-up status. For example, one having a routine priority can appear as a blue pop-up window that disappears after a few seconds to be read in the normal course. Conversely, a notification having an urgent priority but does not require immediate attention can appear in a pop-up window having a yellow color and be accompanied by a single beep tone, and would not disappear until selected by the recipient(s). A notification having an urgent priority and does require immediate attention can appear in a pop-up window accompanied by three beeps, and would not disappear until appropriate action is taken. Thereby, dispatchers can be notified of events, emergencies, outages, traffic patterns and the like. In one embodiment, the application can generate automated notifications relating to certain events by creating date-sensitive notes to notify all dispatchers of information particular to that date when logging on or otherwise initiating the application. Preventative maintenance, operator illness or vacation, vehicle damage or recalls, and the like can cause the application to send notices to one or more dispatchers, preferably ones affected by the events. In response, the dispatcher(s) can alter, modify or otherwise change routes, vehicle assignments, operators or take other action as necessary.

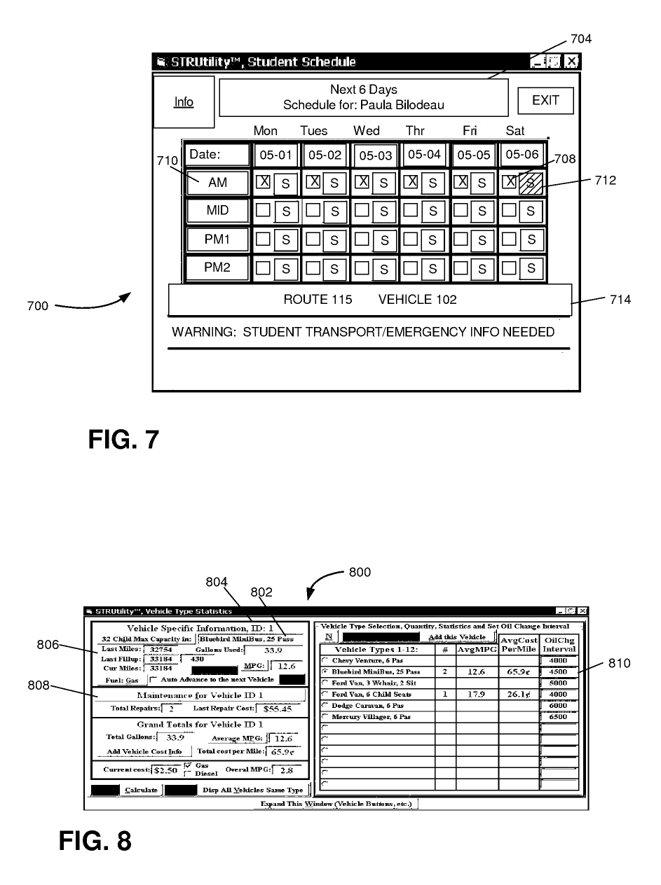

Changes to routes, vehicle assignments, operators, passengers and/or schedules can be made in a variety of ways. FIG. 7 shows one embodiment of a student schedule screen 700 allowing a dispatcher or user to modify a student's schedule in response to an exception request or other event. As illustrated, a schedule screen 702 is displayed for a selected student 704, here for a 6-day period indicated by dates 706. Check boxes such as box 708 indicate that the student is scheduled for transportation during the morning (box 710). A dispatcher or user can position or otherwise select a box 712, whereafter a route number and vehicle identifier is displayed in an information screen 714. The dispatcher can add, remove or otherwise modify a schedule by selecting/deselecting a check box such as check box 708. Should a schedule be added, the dispatcher is prompted to provide additional information, e.g., first location, second location, vehicle, and the like. In any event, changes to the schedule are stored in the database, and hence, other dispatchers are alerted to the change on the date(s) of the exception(s). In one embodiment, after a change is made, other dispatchers are blocked from making further changes in response to the exception request, thus ensure that multiple vehicles are not sent to the same location for a requested pickup.

The application can have functionality to track vehicle statistics useful for maintenance of the fleet, e.g., preventive maintenance, repairs, scheduling of repairs and the like. Further, costs associated with the fleet, e.g., acquisition, operating, maintenance, can be tracked. While those and other maintenance and associated data can be stored, edited, updated and/or accessed, those are but a few examples.

FIG. 8 shows one embodiment of a vehicle statistics screen 800 that displays certain characteristics related to a type of vehicle, here, a Bluebird 25-passenger Minibus as shown in box 802, and also denoted by vehicle identification number 1 804. Mileage, for example, can be displayed in a mileage window 806, and can be used to schedule preventive maintenance, e.g., oil changes, filter changes, brake inspections and the like. The maintenance can be scheduled, and notification can be transmitted to responsible dispatchers using the automated notification features described above, however, the notifications need not be automated.

The application described above can, in other embodiments, provide features and characteristics. For example, an application can have global positioning satellite (GPS) functionality for tracking or locating vehicles, operators or other items of interest, and that can be useful for maintaining schedules, ascertaining traffic conditions and for other needs. An application can import and/or export route, schedule and other information from a wide variety of sources such as programs, downloadable files or XML, or other sources. An application can provide report generation in a wide variety of formats. Those are but a few examples and those skilled in the art will appreciate that modifications are within the scope of the invention.

Thus, in view of what is described above, the illustrated embodiments of methods and applications for providing automated dynamic dispatching for vehicles can be understood. The invention, however, is not limited to the illustrated embodiments, but rather, variations, modifications and adaptations to various methods and application will occur to those skilled in the art, and those are considered to be within the spirit and scope of the invention. Accordingly, the invention is not to be limited by what has been particularly shown and described, but is understood to encompass such variations, modifications and adaptations as will occur to those skilled in the art, as defined by the claims appended hereto and equivalents thereof.

What is claimed is:

1. A method for dispatching a transportation vehicle having a dynamically changing route, the method comprising:
receiving an exception request to modify a route, the exception request having an identifier identifying a cargo item;
identifying a route and a transportation vehicle associated with the cargo identifier; communicating to an assigned dispatcher the identified cargo item, the identified route and the identified vehicle;
modifying at least one of the group consisting of the identified route and the identified vehicle;
communicating the modified route to an operator of the vehicle the modified route; and
blocking any other dispatcher from modifying the identified route in response to the exception request.

2. The method of claim 2, further comprising:
(i) determining a route for the vehicle, the route having one or more first locations for gathering one or more cargo items, and one or more second locations for discharging one or more of the cargo items, each of the first and second locations having an associated time of arrival;
(ii) associating one or more vehicles to the route, the vehicle selected corresponding to a type and number of associated cargo items associated with the route;
(iii) assigning an operator to the associated vehicle, the operator assigned according to a type of vehicle and a type and maximum number of cargo items to be disposed in the vehicle at a given time; and
(iv) assigning a vehicle dispatcher to dispatch the vehicle according to the route.

3. The method of claim 2, wherein the step of determining a route further comprising the steps of:
(i) selecting a set of cargo items in a route, the selection a function of the first location and second location associated with the item;
(ii) selecting from a set of vehicles a type of vehicle corresponding to a number of cargo items along a route;
(iii) ordering a sequence of first locations according to a first location arrival time; and
(iv) ordering a sequence of second locations according to a second location arrival time.

4. The method of claim 1, wherein the step of modifying at least one of the routes and one of the vehicles further comprises any of the group consisting of:
(i) removing a first location from the route;
(ii) adding a first location to the route;
(iii) removing a second location from the route;
(iv) adding a second location to the route;
(v) associating a further vehicle to the route; and
(vi) associating a cargo item to a further route.

5. The method of claim 1, wherein the cargo item is a special needs student.

6. The method of claim 5, the step of modifying at least one of the group consisting of the identified route and the identified vehicle further comprises modifying the identified vehicle according to special needs of the identified cargo item.

7. The method of claim 2, wherein the first location is a home address.

8. The method of claim 2, wherein the second location is a school.

9. The method of claim 2, further comprising:
(i) storing vehicle usage criteria based upon a route;
(ii) modifying the vehicle usage criteria according to the modified route;
(ii) scheduling maintenance of the vehicle based on the modified usage criteria of the vehicle;
(iv) generating an exception request based on the scheduling of maintenance, the exception requesting having a vehicle identifier;
(v) communicating the exception request and the vehicle identifier to an assigned dispatcher of the identified vehicle; and
(vi) modifying the route to which the vehicle identified for maintenance is associated such that the vehicle identified for maintenance is not associated with the route.

10. The method of claim 5, the step of modifying at least one of the group consisting of the identified route and the identified vehicle further comprises modifying the identified vehicle according to special needs of the identified cargo item.

11. An application for dispatching a transportation vehicle having dynamically changing routes, the application comprising:
(i) a database adapted to be populated with one or more routes, each route having one or more associated cargo items, each cargo item having an identifier, each cargo item also having a first location and a second location and an associated time or arrival associated with each of the locations, each route having one or more associated vehicles, each vehicle having one or more associated operators, and each route having one or more associated dispatchers;
(ii) an exception request notification adapted to be communicated to a dispatcher associated with one or more of cargo items identified in an exception report;
(iii) the database further adapted to store a modified route, the modified route entered by one or the one or more associated dispatchers; and
(iv) a route modified notification adapted to be communicated to at least any dispatcher associated with the modified route, the notification advising that the route has been modified in response to the exception report.

12. The application of claim 11, further comprising a vehicle tracking sub-system, the tracking sub-system locating one or more vehicles traveling along the one or more routes, the location communicated to the one or more dispatchers associated with the one or more routes.

13. The application of claim 12, wherein the vehicle tracking sub-system comprises a global positioning satellite communication link.

14. The application of claim 11, wherein the database is further adapted to store and retrieve vehicle operating characteristics.

15. The application of claim 14, further comprising:
(i) a scheduling sub-system that schedules preventative maintenance for the one or more vehicles based on vehicle operating characteristics of the one or more vehicles; and
(ii) the scheduling sub-system generates an exception request based on the schedule for preventative maintenance, the exception request communicated to one or more dispatchers associated with routes that are associated with a vehicle identified in the exception request, one of said dispatchers modifying one or more routes to which the one or more vehicles identified in the exception request are associated.

16. The application of claim 11, wherein the application is adapted for use on a digital processing system.

17. An improvement for increasing efficiency in a transportation company, the improvement comprising:
(i) Receiving an exception request having an identifier, the exception request identifying a cargo item and requesting a change to one or more routes for which the cargo item is associated;
(ii) identifying one or more vehicles associated with the route associated with the identified cargo item;
(iii) communicating to one or more dispatchers associated with the said route the exception request;
(iv) modifying the said route;
(v) communicating the modified route to an operator of the identified vehicles;
(vi) notifying at least the other dispatchers associated with the modified route that the route has been modified; and
(vii) modifying maintenance records associated with the one or more vehicles associated with the modified routes.
